(19) United States
(12) Patent Application Publication
(10) Pub. No.: US 2008/0294988 A1
(43) Pub. Date: Nov. 27, 2008

(54) PORTABLE ELECTRONIC CHECKLIST SYSTEM

(76) Inventors: Paul Daniel Nicholas, Gainesville, GA (US); David Basha, Suwanee, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/751,729

(22) Filed: May 22, 2007

(51) Int. Cl. G06F 3/00

(52) U.S. Cl. 715/710

(57) ABSTRACT

A checklist system comprising a computer and portable unit, according to one implementation, is described herein. The computer of the checklist system is configured to store a first portion of checklist software and one or more checklists. The computer is also configured to download checklists and software updates from a data network. The portable unit of the checklist system is configured to store a second portion of checklist software, where the second portion of checklist software is configured to operate in conjunction with the first portion of checklist software. At least one portion of the portable unit is configured to communicate with the computer in a data-sharing mode. In addition, the portable unit is configured to operate in a checklist-item-prompting mode when the at least one portion of the portable unit is removed from communication with the computer.

### TECHNICAL FIELD

The present disclosure generally relates to checklists for listing a number of procedures to be performed by a human. More particularly, the disclosure relates to electronic checklist systems for automatically prompting the human to perform a list of tasks.

### BACKGROUND

Checklists are used in many professions to guide a human through a number of items to be performed to accomplish complex or lengthy operations. For example, in the field of aviation, a pilot or inspector follows a list of pre-flight procedures to confirm the condition of an aircraft before an aircraft is ready for take-off. Other professions, such as, for example, medical personnel, racing car crews, etc., use checklists to prompt them through a list of procedures to be done. Without a checklist, a person may be required to recall a list of procedures from memory. In stressful or emergency situations, however, a person might overlook or forget important steps. When certain items are skipped or missed, the result can be harmful or even fatal.

Many checklists are typically maintained in the form of cards or paper, which may be preserved in some manner, such as by lamination or placement in a notebook, etc. However, research has found that human error comes into play when paper checklists are involved. In some cases, such as in the medical field or in the field of aviation, missing a critical task could result in serious consequences. When distracted, interrupted, stressed, or not fully alert for some other reason, a human may fail to complete every item of a list, and even miss an important task that may be required or critical for safe operation of an aircraft or for safely performing a medical procedure.

In order to reduce the number of errors caused by humans when paper checklists are used, electronic checklists have been developed to automatically step a person through a list of items. Since an electronic device would not be distracted as a human would be, an electronic checklist device can be used to reduce the number of errors when important checklists are to be followed. Although some electronic checklist devices have helped to reduce errors by eliminating many potential human errors, still further improvements can be made to electronic checklist devices.

### SUMMARY

Electronic checklist systems and devices are described herein for providing a list of tasks to be performed. In one embodiment, among others, an electronic checklist device comprises a portable housing, which supports a memory device, an output system, and an input system. The housing also includes an interface port. The memory comprises erasable non-volatile memory that is configured to store multiple checklists, wherein each checklist includes a list of tasks to be performed by a person. The output system is configured to prompt the person to perform tasks from one of the checklists. The output system can provide an audible human voice output and a visual display output. The input system includes a keypad and a voice recognition system for receiving voice signals and is configured to receive input from the person. The interface port is configured to communicate with an external computer. The memory is further configured to receive changes to the checklists from the external computer via the interface port.

In other embodiments, checklist systems are described, wherein one system includes a computer and a portable unit. The computer is configured to store a first portion of checklist software and one or more checklists. The computer is also configured to download checklists and software updates from a data network. The portable unit is configured to store a second portion of checklist software, the second portion of checklist software being configured to operate in conjunction with the first portion of checklist software. At least one portion of the portable unit is configured to communicate with the computer in a data-sharing mode. The portable unit is further configured to operate in a checklist-item-prompting mode when the at least one portion of the portable unit is removed from communication with the computer.

In an embodiment of a system of the present disclosure, the system comprises means for interfacing with a checklist source to receive a plurality of checklists designed to prompt a user through a list of tasks to be performed. The system further includes means for storing the plurality of checklists and means for receiving an input to select one or more of the checklists. Also, the system includes means for providing the selected checklist to a user, wherein the means for interfacing is further configured to receive new or revised checklists from the checklist source.

Other systems, methods, features, and/or advantages of the present disclosure will be or may become apparent to one having skill in the art upon examination and understanding of the following drawings and detailed description. It is intended that all such additional systems, methods, features, and/or advantages be included within this description and protected by the accompanying claims.

### BRIEF DESCRIPTION OF THE DRAWINGS

Many aspects of the embodiments disclosed herein can be better understood with reference to the following drawings. The components in the drawings are not necessarily to scale, emphasis instead being placed upon clearly illustrating the principles of the present disclosure. Like reference numerals designate corresponding parts throughout the several views.

FIG. 1 is a schematic diagram depicting an embodiment of an electronic checklist system.

FIG. 2 is a block diagram of an embodiment of the computer shown in FIG. 1.

FIG. 3 is a block diagram of an embodiment of the base unit shown in FIG. 1.

FIG. 4 is a front view of an embodiment of a housing for the base unit shown in FIG. 1.

FIG. 5 is a front view of an embodiment of a display device of an electronic checklist device.

### DETAILED DESCRIPTION

Electronic checklist devices have been developed over the past several years to automatically lead a human through a list of checklist items to be performed for critical or complex operations. These electronic checklist devices can be used in a variety of fields or professions. In the present disclosure, electronic checklist systems are described with respect to the field of aviation. However, it should be recognized that these systems and their related methods and functionality may also be used in other fields or professions as understood by one of ordinary skill in the art.

According to consumer demand and need, an electronic checklist device has been desired that is more intuitive, more thorough, and more flexible than conventional devices. In addition, consumers have a need for an electronic checklist device that is portable, relatively inexpensive, voice responsive, and provides both textual and clearly audible prompts. The present disclosure describes embodiments of electronic checklist devices and related methods and functionality to address these needs and demands and which further includes other user-friendly features to improve upon conventional checklist devices. In this respect, the present disclosure describes electronic checklist systems for ensuring safe and thorough performance of checklist items.

FIG. 1 is a diagram illustrating in general an embodiment of an electronic checklist system 10. The electronic checklist system 10 in this embodiment includes a computer 12 and a base unit 14. Checklist software, as described herein, can be stored in the computer 12 and base unit 14 for managing the functions of the electronic checklist system 10. The checklist software allows a user to download checklists from a data network for storage in the computer 12 and then upload the checklists from the computer 12 to the base unit 14. Also, the software can transfer log information of previous checklist operations performed in the field from the base unit 14 to the computer 12.

Utilizing the computer 12, a user can access the data network or even a web site associated with storage of checklists and/or checklist templates. Selections can be made in this respect from an online library. It has also been contemplated that web access to such a site can be limited to users having a paid membership to the site. In this case, the web site delivers checklists and/or checklist templates to members only. In some embodiments, checklists can be stored on a storage medium, such as a compact disc (CD) and delivered via a regular mail service. In still other embodiments, checklists can be delivered via e-mail or other suitable electronic file transfer system. As described herein, checklists delivered to the computer 12 can be in the form of a checklist template that includes an outline for creating a unique checklist. In this respect, the template may include few or even no checklist items or checks, but can be filled in by the user as desired. In other embodiments, the checklist templates may include complete checklists that need no further modification on the user's part.

When a checklist template is downloaded to the computer 12, the user can alter the checklists using software on the computer 12. Also, the user can test the checklists by running a simulation routine on the computer 12. The simulation routine is stored in the computer 12 and allows the user to proceed through checks in a simulated environment. The simulation routine may produce audible and visual outputs similar to actual use of the base unit 14 in the field. The visual outputs may include an image of the base unit and simulated operations of the base unit.

In a data-sharing mode, the computer 12 and base unit 14 can communicate with each other via a cable 16, as is shown in FIG. 1, or using another suitable wired or wireless communication channel. For the cable 16 to be used as a data sharing interface between the computer 12 and base unit 14, the cable 16 may include appropriate plugs or terminals for connection to the computer 12 and base unit 14. For example, the terminals of the cable 16 may conform, for example, to a universal serial bus (USB) port to any other suitable bus, terminal, interface, etc. Likewise, the computer 12 and base unit 14 include corresponding interface ports for connection with the cable 16.

In the data-sharing mode, the computer 12 can transmit checklists to the base unit 14, which is configured to store the checklists in firmware within the base unit 14. In addition, the base unit 14 can transmit checklists to the computer 12 for further editing, simulation, etc., by way of the computer 12. In this regard, when the checklists are edited, the computer 12 can transmit them back to the base unit 14 after the modifications are done.

Also, when previous checks have been made and a log of the checks is stored in the base unit 14, the base unit 14 can transmit the log information to the computer 12 for storage in the computer 12. When the base unit 14 is disconnected from the computer 12 and cable 16, the base unit 14 can be carried to any on-site location for providing checklist instructions to a user and for logging the times and dates that the checklist items were completed or confirmed.

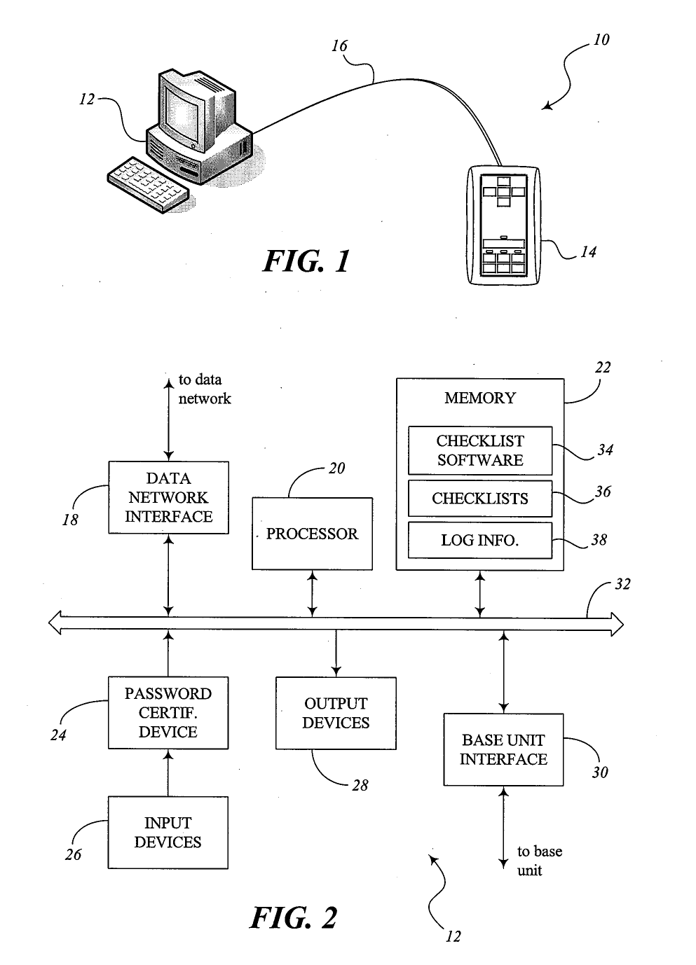

FIG. 2 is a block diagram illustrating an embodiment of a portion of the computer 12. The computer 12 in this implementation includes a data network interface 18, a processor 20, memory 22, a password certification device 24, input devices 26, output devices 28, and a base unit interface 30. The components of the computer 12 are connected directly or indirectly to an internal bus interface 32 allowing the components to communicate with each other as needed. The memory 22 is configured to store checklist software 34, a number of checklists 36, and log information 38.

The input devices 26 may include keyboards, keypads, computer mice, or other suitable user-input device allowing a user to enter information or commands. The output devices may include computer monitors, speakers, or other suitable output devices for presenting information to the user. In this embodiment, the password certification device 24 acts as a gate that only allows a user to access the files, settings, checklists, and other data when an appropriate password is first provided. If the user does not enter the correct password, the password certification device 24 prevents inputs through the input devices 26 from being accepted. This is a security feature to prevent an authorized person from tampering with the settings or checklists stored on the computer 12 or base unit 14. For instance, with a flight instructor's password, a student pilot would not be able to change or access certain sensitive data. In addition, the password certification device 24 may also prevent unauthorized users from downloading checklists into the computer 12 and/or uploading checklists from the computer 12 into the base unit 14. In other embodiments, the password certification device 24 may be omitted and the input devices are connected directly to the internal bus interface 32.

Generally, the processor 20 controls the operation of the other components of the computer 12. The memory 22 may include random access memory (RAM), read-only memory (ROM), and/or other types of memory. The checklist software 34, which may be stored in ROM, for example, includes logic for performing steps or procedures of a checklist program as described herein. The memory 22 includes sufficient capacity in order to store any desirable number of checklists. The checklist software 34 enables the user to add or delete checklists 36 as desired. The processor 20 functions to run the checklist software 34 and perform many actions based on user input.

The data network interface 18 may include a modem, such as a cable modem, or any other suitable transceiver or two-way communication device for communicating with a data network, such as the Internet. The data network may store electronic checklists in memory, which can be retrieved, such as via a web site, when requested by the user. Files of the electronic checklists can be downloaded from the data network via the data network interface 18 and stored in memory 22. The data network interface 18 can therefore download checklists 36, updates to the checklist software 34, etc., from the data network.

Furthermore, the base unit 14 may be constructed with certain hardware components, e.g. carbon monoxide detector, cabin depressurization sensor, etc., built into the base unit 14. However, these components can be disabled by an encryption code, but can be enabled when the user pays for service of one or more of these optional components. When an optional component is purchased, decryption code can be downloaded to the computer 12 and stored in memory 22. The decryption code can then be uploaded into the base unit 14 enabling the one or more optional components to be used.

The checklist software 34 may be designed to download updates in the software code or download new or revised checklists from the data network. In addition, the memory 22 may include, or interface with, one or more memory card readers (not shown), which are capable of reading data from and writing data to external memory cards. The memory card readers may include a configuration conforming particular standards, such as Secure Digital (SD), Compact Flash (CF), or other suitable memory card formats. In this way, the computer 12 can share data with a memory card that can be removably installed in the base unit 14.

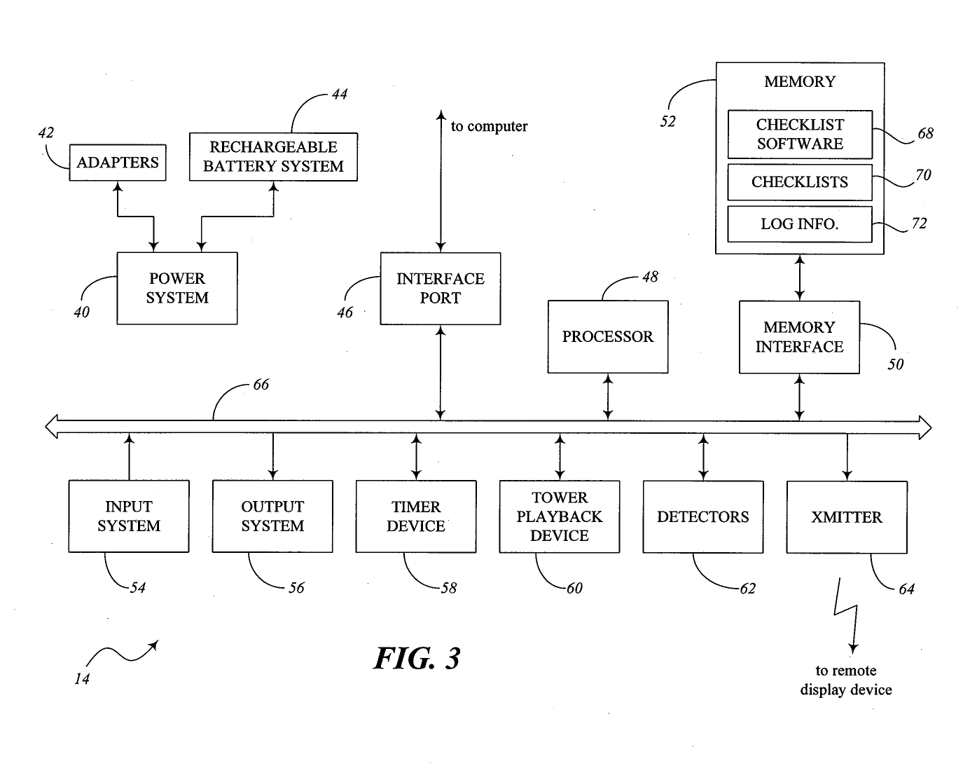

FIG. 3 is a block diagram of an embodiment of the circuitry of the base unit 14 shown in FIG. 1. The base unit 14 in this embodiment includes a power system 40, adapters 42, and a rechargeable battery system 44 for providing power to the components of the base unit 14. The base unit 14 also includes an interface port 46, processor 48, memory interface 50, memory 52, input system 54, output system 56, timer device 58, tower playback device 60, detectors 62, and transmitter 64. These components are interconnected via an internal bus 66 allowing communication between the components. The memory 52 in this implementation includes, for example, checklist software 68, one or more checklists 70, and log information 72. In some embodiments, the memory 52 is configured in non-volatile firmware to prevent loss of information if the power system 40 discharges its resources to the point that it does not provide sufficient power to the base unit 14.

The power system 40 may contain suitable amplifiers, attenuators, and other circuitry for providing constant power to the components of the base unit 14. The power system 40 is connected to adapters 42 for receiving power from an external source. The adapters 42 may include a 12-volt input for connection to a 12-volt adapter of a cockpit, for instance, for converting 12 volts to a suitable power for powering the base unit 14. The adapters 42 may also include a 24-volt input for connection to a 24-volt adapter.

The rechargeable battery system 44 includes rechargeable batteries, which may be removed for recharging or may be recharged by a recharging device of the rechargeable battery system 44. The power system 40 may function to control the recharging of the batteries. When the base unit 14 is connected to an external power source, such as an aircraft battery, the power system 40 not only provides power to the base unit 14 but also controls recharging of the rechargeable batteries. When the base unit 14 is disconnected from an external power source, the rechargeable batteries can provide enough power for a certain amount of time, e.g. approximately four hours. In addition, the adapters 42 may further include an adapter allowing the base unit to be plugged into a conventional 110-volt wall outlet. In this way, the user can practice with the base unit 14 in a home or office if desired.

The interface port 46 includes circuitry and hardware for communication with the computer 12 and may be configured as a USB port or other suitable port for connection to the computer 12 via the cable 16 (FIG. 1). In the data sharing mode, as mentioned above, the cable 16 is connected to the interface port 46 enabling the computer 12 and base unit 14 to share data, information, checklists, log information, etc.

The memory interface 50 controls the reading and writing of data and information to the memory 52. The memory 52 may include a removable memory card, such as a Secure Digital (SD) memory card, Compact Flash (CF) memory card, etc., which can be replaced with another memory card, if desired, to provide additional checklists. The checklist software 68 in memory 52 includes software for operations related to the base unit 14 and corresponding programs for operations related to communicating with the computer 12. The checklist software 68 may also include software having overlapping logic with respect to the checklist software 34 in memory 22 of the computer 12 (FIG. 2). The memory 52 of the base unit 14 can also store one or more checklists 70 depending on the complexity of each. The checklists 70, for example, can be uploaded from the computer 12. During use, the memory interface 50 stores log information 72, such as time stamp information and date stamp information of a user's response to prompts or commands from the base unit 14.

With respect to storage capabilities, the memory may include sufficient storage space to store multiple checklists for multiple aircraft. Because of the versatility of the electronic checklist system 10, the base unit 14 can be used in several environments depending on the particular needs of the user. In some embodiments, the memory 52 may be configured as a memory card or other type of removable memory device in order that the memory 52 can be inserted into a respective memory card reader or other suitable slot in the computer 12. It has also been considered that the user could store different checklists on different memory cards and connect one of the memory cards in the base unit 14 according to need. Another feature of the memory 52 is that it is non-volatile, such as flash memory, to prevent loss of data if the power of the aircraft is down or the base unit is disconnected from the aircraft and the charge of the batteries is depleted.

The memory 52 can store any type of checklists 70 as desired for any use or profession. The stored checklists 70 may also include customized checklists, as explained below. With respect to the field of aviation, the base unit 14 may be configured, for example, for use in three different stages of operation, including, for example, a “pre-flight” stage, an “in-flight” stage, and a “post-flight” stage. Each of these stages may include one or more sets of checklists 70, or sub-checklists, for different phases of operation within those stages. For example, for the pre-flight stage, the base unit 14 may be used for checks including “before start”, “start”, “after start”, “taxi”, “run up”, and “take off”. The checklists 70 stored in the base unit 14 may include checklists, sub-checklists, sub-sub-checklists, etc., as needed, depending on the particular complexity and specificity of the checks being performed and the particular use or profession to which they apply.

Referring again to the aviation example, the different checklists 70 may include different instructions based on a particular “mode”. The modes used in this example include a “normal” mode, an “abnormal” mode, an “emergency” mode, and a “custom” mode. It should be understood the checklists may include fewer or more modes or even different modes as needed and as designed for the particular application. In the “normal” mode, an aircraft may be checked under normal or regular conditions and a standard checklist is used in this case. When the user switches to the abnormal mode, a set of choices for additional checklists may be presented for selection according to the abnormality of the situation. For example, when a pilot is taking off from a runway that is not normal but one that is considered as a short runway, a “short runway” checklist may be selected for prompting the pilot with instructions to proceed through this condition.

When the user switches to the emergency mode, the base unit 14 provides a menu of choices depending on the present emergency. In this respect, the available emergency checklists are “context-sensitive” or based on the particular stage of flight that the aircraft is currently in. For example, one set of checklist choices are provided during pre-flight checklists and another set of checklist choices are provided during in-flight checklists. By narrowing the choices to the particular context of the flight, the base unit 14 provides choices from which the user can easily select. When the particular emergency is identified and the corresponding checklist for that emergency is selected by the user, the base unit 14 can provide emergency instructions for getting through the emergency.

In addition to the normal mode, abnormal mode, and emergency mode, the fourth mode of operation includes a custom or customized mode. In this mode, the user may utilize a checklist that has been specifically designed by the user according to the user's needs. In this respect, the user has the ability to change any checklist in the system to customize the list to their liking. In particular, the user may use the computer 12 or base unit 14 to enter customized checklists or checklist items, or even alter existing checklists.

Referring again to FIG. 3, the electronic checklist system 10 may also include a checklist logging system. The checklist logging system logs the time and date that the user performs the tasks of the respective checklist and stores the log information 72 in memory 52. The time stamps and date stamps of checks can provide evidence for future reference that certain steps were actually followed. This evidence may be used if the user is questioned concerning the tasks performed. Also, in a training scenario, an instructor can record whether or not a student pilot performs the checklist items accordingly.

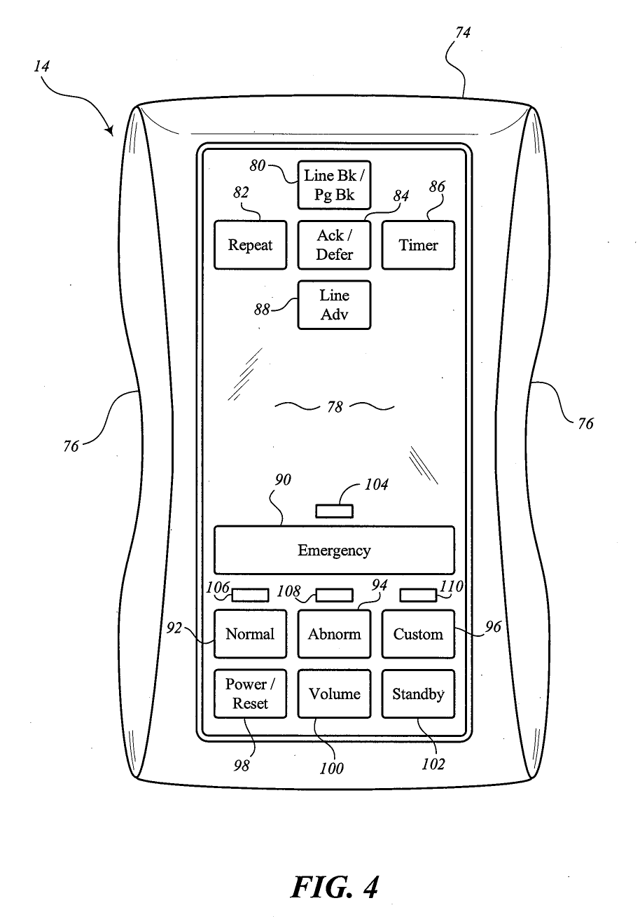

The input system 54 includes any suitable mechanisms for inputting data or instructions into the base unit 14. For example, the input system 54 may include a keypad, as described in more detail with respect to FIG. 4, a pressure sensitive pad for use with a stylus, or other suitable physically-activated input device. The input system 54 can further include a microphone or other suitable audio-receiving device for receiving voice commands from the user. With respect to being voice responsive, the input system 54 may further include a voice recognition device for recognizing particular spoken commands or instructions, such as “next line”, “acknowledge”, etc. The voice recognition device may be trained for a particular user or users to more easily recognize different users' voices.

The output system 56 includes any suitable mechanisms for outputting data or instructions from the base unit 14 to the user. For example, the output system 56 may include a display device for displaying textual information, one or more speakers for audibly communicating information to the user, etc. In addition, the output system 56 may include plugs, terminals, etc., for connecting an audible output to an external audio system, such as the audio system of an aircraft.

The speakers of the output system 56 can provide audible instructions to the user to perform a task in the respective checklist. The audible instructions are preferably spoken instructions in the tone of a female or male voice. The user can select preferences with respect to the speech output from the base unit 14. For example, in addition to the user selecting either a female voice or male voice, the user may also select the speech rate or cadence of the spoken voice. The user can also select a language, e.g. English, Spanish, French, etc. Other speech qualities can be varied including inflections, accents, modulations in tone, speech flow, pauses, etc.

The checklist software 34 on the computer 12 is capable of converting the spoken instructions of each task of each checklist into a JPEG format in order that the natural sound of a human voice can be substantially synthesized and preserved. The JPEG voice files of the checklist instructions are stored along with the checklist 70 in memory 52 in the base unit 14. The checklist software 34, 68 on the computer 12 and base unit 14, respectively, can also customize the pronunciation of certain difficult words and can also utilize a custom dictionary for certain abbreviations of difficult words.

The timer device 58 includes a timing mechanism for counting up or down depending on the particular application. For example, the base unit 14 may be configured to repeatedly and periodically provide instructions or checks when the user has not acknowledged completion of the instruction. In this case, the timer may provide an indication that a certain amount of time has passed, e.g. 30 seconds, and a reminder of the current instruction can be repeated. The timer device 58 may be useful to remind the user of an uncompleted task, for instance, when the user is distracted or interrupted. In another example, the timer device 58 may be used when the pilot is flying an aircraft using instruments only. If flying through dense clouds, for example, the pilot may be informed that a runway should be visible in a certain amount of time. The pilot can then request that the timer device 58 provide an indication when that amount of time has been reached and may also request that the timer device 58 provide intermediate indications of time leading up to the end of the time period.

The tower playback device 60 is configured to record and buffer incoming transmissions from a control tower, or can record any audible information for a certain amount of time. The audible signals are buffered for a predetermined amount of time. If the pilot is distracted when the transmission is made or does not understand the entire message, the pilot can request that the message is repeated.

The base unit 14 may also include one or more different types of detectors 62 for detecting environmental conditions and/or flight conditions. For example, one detector that can be built into the base unit 14 is a carbon monoxide (CO) detector for detecting dangerous levels of CO. The base unit 14 may also have a cabin depressurization sensor for detecting if the pressurization within the cabin of the aircraft drops below a safe condition. Also, an altitude-warning device may be incorporated within the base unit 14 to detect dangerously low altitude flight or dangerous altitude changes.

The transmitter 64 of the base unit 14 may be an optional component depending on whether the base unit 14 is used in a split system. The split system in this respect refers to the base unit 14 and a remote device. The remote device may include visual capabilities, such as presenting text, and/or audio capabilities for providing audible instructions. When used with a remote display, the base unit 14 transmits display and audio information via the transmitter 64 to the remote device. In this scenario, while the user holds the base unit 14, the remote device may be attached to a surface, for example, which may be easy to see.

FIG. 4 is a diagram showing a front face of the base unit 14 according to one embodiment. In this embodiment, the base unit 14 includes a housing 74, which is capable of supporting and protecting the base unit's circuitry shown in FIG. 3. The base unit 14 also includes grips 76 on the sides of the housing 74 for easy and ergonomic handling. Arranged near a middle portion of the base unit 14 is a display screen 78 for displaying checklist items to be performed. Arranged near a top portion of the base unit 14 are a “line back/page back” button 80, a “repeat” button 82, an “acknowledge/defer” button 84, a “timer” button 86, and a “line advance” button 88. Arranged near a bottom portion of the base unit 14 are an “emergency” button 90, a “normal” button 92, an “abnormal” button 94, a “custom” button 96, a “power/reset” button 98, a “volume” button 100, and a “standby” button 102. In addition, the base unit 14 further includes indicator lights 104, 106, 108, and 110 for indicating an emergency mode, normal mode, abnormal mode, and custom mode, respectively. It should be noted that the base unit 14 may include the illustrated or any other suitable design or configuration for performing the functions as described below. For example, the different buttons may further be designed with different color schemes to easily distinguish between the buttons. The emergency button 90 may be colored red, for example, to highlight this button during a possibly stressful emergency situation.

The base unit 14 is configured as a portable hand-held device that is easy to handle and light weight. For instance, the base unit 14 may be designed to weight less than one pound. The ergonomic grips 76 provide for easy handling. Also, the base unit 14 may include a belt clip on the back of the housing 74 for easy connection to the user's clothing or may include a hook or loop on the outside of the housing 74 for connecting to a lanyard. These or other suitable connection or fastening mechanism can be incorporated into the base unit 14 for easy transport. The base unit 14 may also include a suitable fastening device for convenient positioning on a surface, such as a cockpit panel, or on other object as needed.

Furthermore, the base unit 14 includes a built-in speaker (not shown) for providing audible instructions. The base unit 14 also includes a microphone (not shown) for receiving speech instructions from the user. In this respect, the base unit 14 is designed to be voice responsive to allow a user to utilize the device in a hands-free scenario. By providing this voice responsive capability, the base unit 14 allows a user, such as a pilot, to proceed through a checklist while maintaining control of and focusing on the aircraft, even during an emergency situation. The operation of the base unit 14 may also involve pressing the buttons 80, 82, 84, 86, 88, 90, 92, 94, 96, 98, 100, and 102. In some embodiments, the voice responsive commands from the user or commands entered by pressing the buttons cause the base unit 14 to respond in like manner.

As suggested above, the output system 56 of the base unit 14 may include a built-in speaker system for providing the speech instructions. The base unit 14 is designed to provide a volume that is loud enough to be heard in even a fairly noisy environment. The volume of the sound can be adjusted using a volume button 100 (FIG. 4) of the base unit 14. The base unit 14 and/or the display device 60 may include plugs or sockets for receiving a headset jack to allow a pilot to clearly hear the checklist instructions in a loud environment. The audio signal can also be transmitted wirelessly or via a cable to the aircraft's audio system. In this respect, the procedures can be checked through the yoke mounted switches to allow the pilot to maintain control of the aircraft.

The user has the option to select a particular format in which the checklist instructions are presented. For example, the electronic checklist device may be configured to present the instructions in either a “to-do” list or a “challenge-response” list. With a to-do list, the user is given an instruction to perform a certain task. When that task is completed, the user presses the line advance button 32 to advance to the next line of instruction in the checklist. In the challenge-response list, the user is given an instruction to perform a task. The electronic checklist device may be configured to periodically remind the user to perform the task until it is done. Upon completion, the user presses the acknowledge button 28 to acknowledge that the task is complete. At some point after acknowledgement, the user presses the line advance button 32 to advance to the next item. The to-do list may be beneficial when a list of relatively simple tasks are to be performed continuously and in sequence. For a sequence of longer tasks that can be separated by lengthy pauses, the user may choose to select the challenge-response mode.

The line back/page back button 80 allows a user to back up through the list as needed. When the user presses the repeat button 82, the list instruction is repeated. When acknowledge/defer 84 is pressed, the checklist item is acknowledged or can be deferred until a later time. For example, a checklist item can be skipped and then reintroduced after the next instruction or deferred until the end of the checklist. The base unit 14 also allows the user to skip an entire heading or headings and skip to other checklists upon demand.

In some embodiments, the base unit 14 can also be configured to run in an “auto-check” mode, in which the checklist items are output to the user one after another without a response (acknowledge or line advance) from the user. The auto-check mode provides the checks sequentially with an adequate delay between checks to allow the user to sufficiently perform the check. The timing of the delay between checks can be adjusted according to the user's needs depending on the rate at which the user can perform the given tasks.

The base unit 14 can also be configured to operate in a circuit or loop pattern. In this way, certain checklists that are repetitive, or that include repetitive sequences, can be looped a number of times depending on the number of iterations desired. To proceed past the loop, the user can request to proceed to the next portion of the checklist when the base unit 14 has repeated the loop iterations sufficiently.

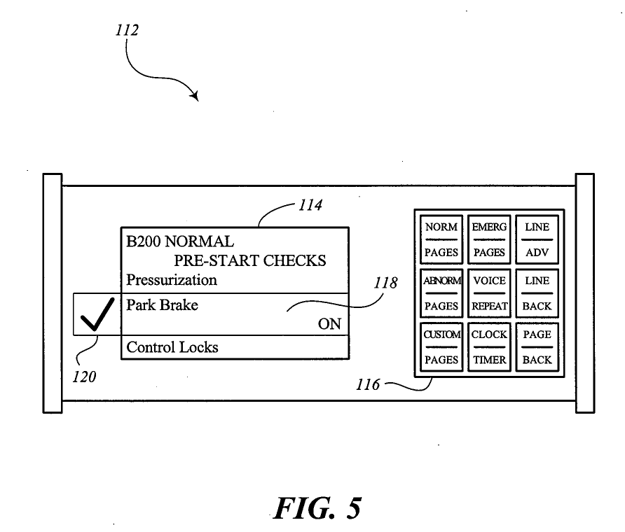

FIG. 5 is a diagram of an embodiment of a remote device 112, which may be used in conjunction with the base unit 14. It should be noted that the base unit 14 may be used with or without the remote device 112. As mentioned above, the base unit 14 provides checklist tasks in the form of audible signals via one or more internal speakers and/or visible signals via the display 78 (FIG. 4). However, if another visual display other than the base unit's display is desired, the remote device 112 can be used as well to supplement the other outputs. As mentioned above, the base unit 14 may include a transmitter 64 for transmitting display signals and/or audio signals to the remote device 112.

The remote device 112 in the embodiment of FIG. 5 includes a display screen 114 and a group of toggle switches 116. The toggle switches 116 allow input of user commands generally corresponding to the same commands related to the buttons on the base unit 14. The display screen 114 includes a window 118, which shows a current task to be performed in the checklist. In this example, the electronic checklist device audibly and/or visually outputs or presents the current task involving the “park brake”. During this “pre-start” check in a “normal” mode, the park brake should be “ON”. The display device 60 further includes an indicator 68 for indicating which item or task is currently being checked. The indicator 68 may include a checkmark, as shown, or other suitable marking symbol or character. The remote device 112 may further include another output system for providing sound to an external audio system, such as the aircraft's audio system.

Many of these and other features of the base unit 14 may be standard features or may be optional or add-on features. Others may be replaced within the computer 12 or remote device 112, or vice versa. By incorporating the components of the base unit 14 into this single unit, or by incorporating the components in the base unit 14 and remote device 112, a pilot or other user may be able to clearly receive instructions for following a checklist in a safer manner. In this way, the electronic checklist system 10 allows the pilot to concentrate on the tasks at hand without skipping or missing possibly critical steps.

The electronic checklist system 10 of the present disclosure can be implemented in hardware, software, firmware, or a combination thereof. In the disclosed embodiments, the software or firmware is stored in memory of the computer 12 and/or base unit 14 and can be executed by a suitable instruction execution system. If implemented in hardware, the electronic checklist system 10 can be implemented with any combination of discrete logic circuitry, an application specific integrated circuit (ASIC), a programmable gate array (PGA), a field programmable gate array (FPGA), etc.

The functionality of the electronic checklist device may include steps of methods having operation according to the various implementations described herein and configured within software code. In this regard, each step may represent a module, segment, or portion of code, which comprises one or more executable instructions for implementing the specified logical functions.

The functionality of the electronic checklist system 10 may include operations involved with the checklist program of the checklist software 34, 68. The checklist program comprises an ordered listing of executable instructions for implementing logical functions. The checklist program can be embodied in any computer-readable medium for use by an instruction execution system, apparatus, or device, such as a computer-based system, processor-controlled system, or other system that can fetch the instructions from the instruction execution system, apparatus, or device and execute the instructions. In the context of this document, a “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device, or propagation medium.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. An electronic checklist device comprising:
a portable housing;
erasable non-volatile memory configured to store multiple checklists, each checklist including a list of tasks to be performed by a person;
an output system configured to prompt the person to perform tasks from one of the checklists, the output system providing an audible human voice output and a visual display output;
an input system configured to receive input from the person, the input system including a keypad and a voice recognition system for receiving voice signals from the person; and
an interface port configured to communicate with an external computer;
wherein the memory is further configured to receive changes to the checklists from the external computer via the interface port.

2. The electronic checklist device of claim 1, further comprising a processor configured to control the operation of the memory, output system, input system, and interface port, the processor further configured to run checklist software stored in the memory.

3. The electronic checklist device of claim 1, further comprising:
one or more power adapters, each adapter configured to receive power from an external source and to convert the power to an appropriate level for use by the electronic checklist device; and
a rechargeable battery system configured to recharge one or more rechargeable batteries using power from the external source;
wherein the one or more rechargeable batteries provide power to the electronic checklist device when the one or more power adapters are not connected to the external power source.

4. The electronic checklist device of claim 1, further comprising a timer device configured to provide an indication when a certain time period has expired.

5. The electronic checklist device of claim 1, further comprising a playback device configured to record and buffer audio signals over a certain past time period, the playback device further configured to receive a request for the audio signals and to provide an audio output of the audio signals in response to the request.

6. The electronic checklist device of claim 1, further comprising at least one detector selected from the group consisting of a carbon monoxide detector, cabin depressurization detector, and an altitude detector.

7. The electronic checklist device of claim 1, further comprising a transmitter for transmitting signals to a remote display device for displaying checklist items.

8. A checklist system comprising:
a computer configured to store a first portion of checklist software and one or more checklists, the computer configured to download checklists and software updates from a data network; and
a portable unit configured to store a second portion of checklist software, the second portion of checklist software configured to operate in conjunction with the first portion of checklist software, at least one portion of the portable unit configured to communicate with the computer in a data sharing mode, the portable unit further configured to operate in a checklist-item-prompting mode when the at least one portion of the portable unit is removed from communication with the computer.

9. The checklist system of claim 8, wherein the computer comprises memory for storing the checklist software and the one or more checklists, the computer further comprising a password certification device for confirming authorization of a user to run the checklist software.

10. The checklist system of claim 8, wherein the portable unit comprises a rechargeable power system.

11. The checklist system of claim 8, wherein the portable unit comprises a memory configured to store the second portion of the checklist software, the memory further configured to store one or more checklists uploaded from the computer during the data sharing mode.

12. The checklist system of claim 11, wherein the memory of the portable unit is further configured to store log information related to a time and date that tasks of a checklist were confirmed by a user during the checklist-item-prompting mode.

13. The checklist system of claim 12, wherein the portable unit is configured to upload the log information to the computer via an interface during the data sharing mode.

14. The checklist system of claim 8, wherein the computer is configured to upload checklists to the portable unit during the data sharing mode.

15. A system comprising:
means for interfacing with a checklist source to receive a plurality of checklists designed to prompt a user through a list of tasks to be performed;
means for storing the plurality of checklists;
means for receiving an input to select one or more of the checklists;
means for providing the selected checklist to a user;
wherein the means for interfacing is further configured to receive new or revised checklists from the checklist source.

16. The system of claim 15, wherein the means for storing is further configured to store checklist software designed to control operations of the system.

17. The system of claim 15, wherein the means for storing is further configured to store log information corresponding to times and dates that the user performs each task of the selected checklist.

18. The system of claim 15, wherein the means for providing comprises means for visually displaying tasks of the selected checklist and means for audibly presenting the tasks of the selected checklist.

19. The system of claim 18, further comprising means for wirelessly transmitting audio signals to a remote display device, wherein the means for audibly presenting the tasks comprises the remote display device.

20. The system of claim 15, further comprising at least one device selected from the group consisting of means for counting a predetermined time period, means for playing back an audio message, means for detecting carbon monoxide, means for detecting a predetermined drop in air pressure, and means for detecting altitude.
